(19) United States
(12) Patent Application Publication
(10) Pub. No.: US 2016/0047216 A1
(43) Pub. Date: Feb. 18, 2016

(54) WELLSITE PRODUCTION MACHINES

(71) Applicant: Robert Carl Rajewski, Forestburg (CA)

(72) Inventor: Robert Carl Rajewski, Forestburg (CA)

(21) Appl. No.: 14/461,298

(22) Filed: Aug. 15, 2014

(51) Int. Cl. E21B 43/34; E04B 1/00; F23G 7/08; C02F 1/40; B01D 29/60

(52) U.S. Cl. CPC E21B 43/34; C02F 1/40; B01D 29/605; F23G 7/08; E04B 1/00; C02F 2101/32

(57) ABSTRACT

A wellsite production machine has a separator connectable to a wellhead, the separator having a liquids discharge line and a oil discharge level, an oil storage tank having a liquids input port to which the liquids discharge line is connected; and the storage tank having a high level line established by a high level detection apparatus, the oil discharge level of the separator being at or above the high level line of the storage tank so that liquids in the separator may flow by gravity into the storage tank. The separator and a flare stack assembly are also disclosed, along with a method of making the wellsite production machine.

### FIELD

Surface equipment and methods used at oil and gas wells to produce and store fluids at a well site.

### BACKGROUND

The inventor has designed and patented several wellsite production machines including Canadian Patent Nos. 1274785, 2025925 and 2226042. While these designs have been successful, high pressure production packages have become quite expensive and complex.

### SUMMARY

Various components of a wellsite production machine are disclosed including separator, combination separator and oil storage tank, flare stack assembly and method of manufacture.

In an embodiment, there is disclosed a wellsite production machine. The wellsite production machine may comprise a separator connectable to a wellhead, the separator having a liquids discharge line and a oil discharge level, an oil storage tank having a liquids input port to which the liquids discharge line is connected; and the storage tank having a high level line established by a high level detection apparatus, the oil discharge level of the separator being at or above the high level line of the storage tank so that liquids in the separator may flow by gravity into the storage tank.

In another embodiment, there is disclosed a separator, which may be used with the disclosed wellsite production machine. The separator may comprises a vapour tight enclosure, a standpipe extending vertically within the vapour tight enclosure, the standpipe having an upper part and a lower part, an inlet line for fluids from a well, the inlet line opening into the upper part of the standpipe for discharge of fluids from the well into the standpipe, a water level detector in the vapour tight enclosure that defines a water-oil level within the vapour tight enclosure, a water dump control responsive to the water level detector to open when the water level exceeds the defined water-oil level, the lower part of the stand pipe extending below the water-oil level, an oil discharge line having an opening for receiving oil from the vapour tight enclosure and above the water-oil level and a vent for gases to escape from the vapour tight enclosure.

In another embodiment, there is disclosed a flare stack assembly, which may be used with the disclosed wellsite production machine. The flare stack assembly may comprise a flare stack, a dropout tank, an inlet line having an opening into the dropout tank, the inlet line being connectable to a separator, a detonation arrestor line extending out of the dropout tank through a detonation arrestor and downward into the flare stack and a fluids return line between a bottom of the flare stack and the dropout tank.

In an embodiment of a wellsite production machine installation method there is disclosed fabricating concrete support slabs, a separator, a storage tank and height adjustable support posts, transporting the fabricated concrete support slabs, separator, storage tank and height adjustable support posts to a wellsite, mounting the separator and storage tank on the concrete support slabs and height adjustable support posts and levelling and adjusting the vertical location of each of the separator and the storage tank using the height adjustable support posts.

### BRIEF DESCRIPTION OF THE FIGURES

There will now be described preferred embodiments of a wellsite production machine with reference to the figures by way of example, in which like reference characters denote like elements and in which:

FIG. 1 shows a side view of a wellsite production machine including flare stack assembly, separator and oil storage tank;

FIG. 2 shows a top view of the wellsite production machine of FIG. 1, including water storage tank;

FIG. 3 is a detail from FIG. 1 showing a flare stack assembly;

FIG. 3A is a top view detail showing an example of a flare stack assembly with a compressor for discharging gas to a sales line;

FIG. 3B is a top view detail of an alternative embodiment of a flare stack assembly with a compressor for discharging gas to a sales line;

FIG. 4 is a detailed side view from FIG. 1 showing a separator;

FIG. 4A is a detailed side view showing a separator with a syphon water dump;

FIG. 5 is a detail top view from FIG. 2;

FIG. 5A is a top view of an alternative embodiment of the tanks in FIG. 5, in which a tank is divided into oil and water compartments; and

FIG. 5B is a side view of an alternative embodiment of the tanks in FIG. 5, in which there is at least an additional tank connected by an equalizing line.

### DETAILED DESCRIPTION

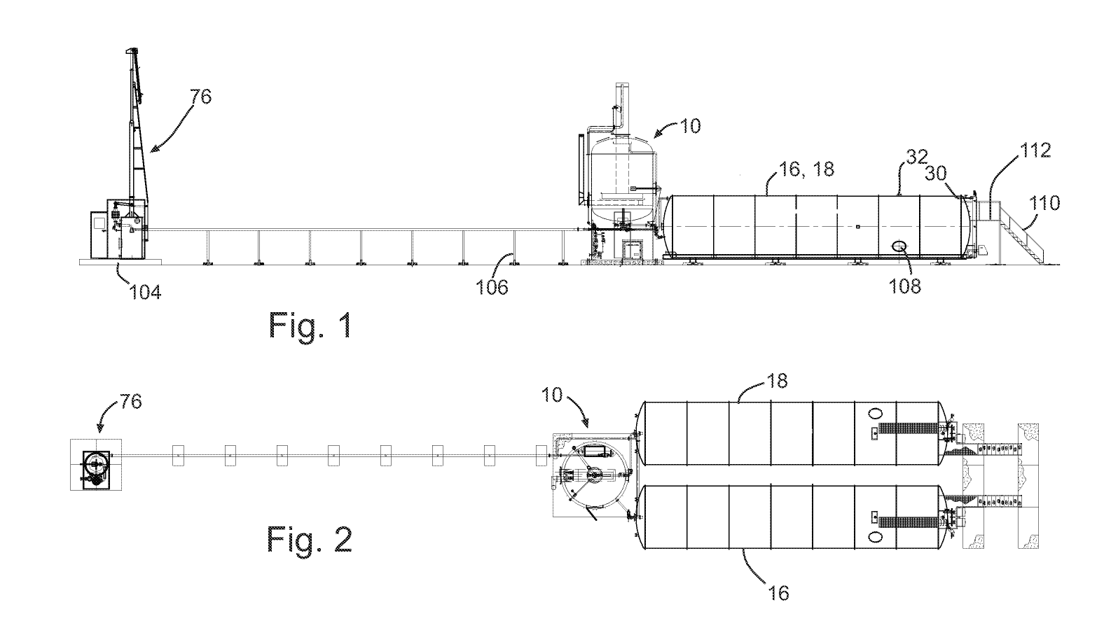

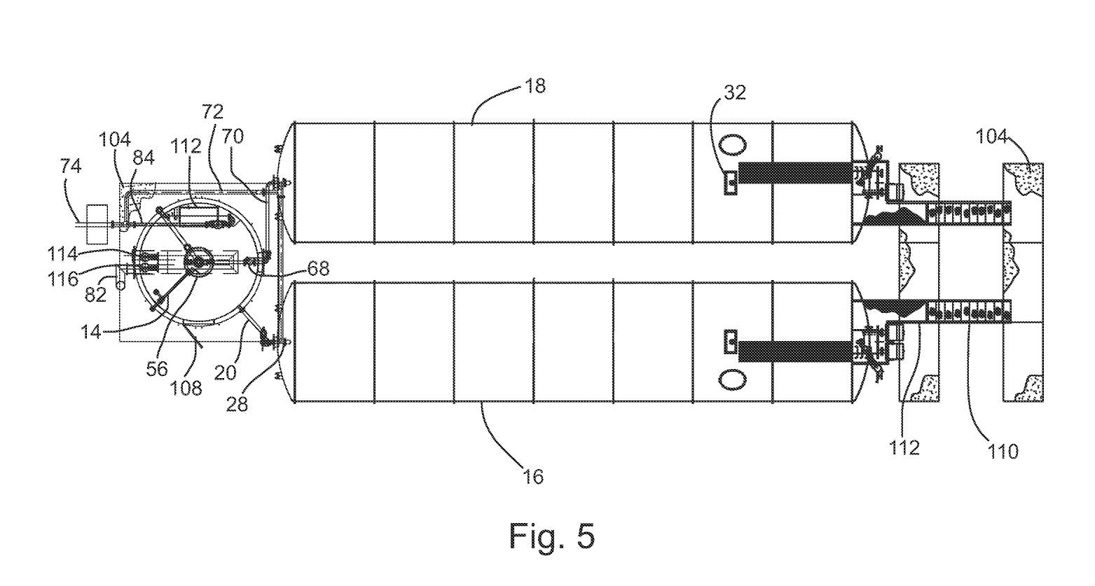

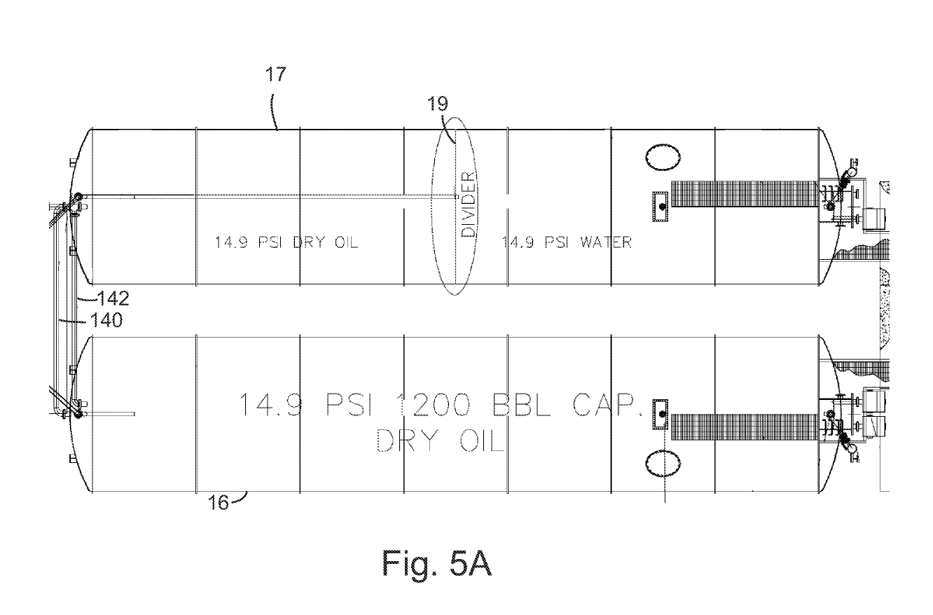

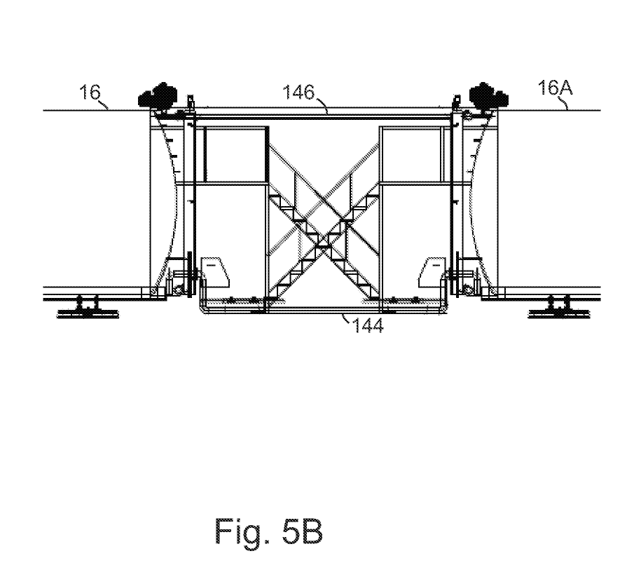

A wellsite production machine is disclosed as illustrated in FIGS. 1 and 2. Novel components are described in detail. Various lines connect the main components and these are not described in detail since they are conventional. The lines may thus comprise connected pipes (lines), fittings, isolation valves, relief valves and gauges as are conventionally used and in many cases required by applicable safety regulations. A separator 10 is connectable to a wellhead 12 by a line 14 and operates in conjunction with an oil storage tank 16 fed gravitationally by the separator 10, and where the oil is wet (which is usual) with a water storage tank 18, also fed gravitationally by the separator 10. Line 14 may be a conventional line or may be an insulated line. Insulating the line 14 saves well production heat reducing the need to add further heat at the separator. Insulating the line also prevents waxing and freezing problems. In some embodiments, neither the separator 10, oil storage tank 16 or water storage tank 18 need be exactly as shown. For example, in some embodiments, the shape, orientation and relative location of the items 10, 16 and 18 may vary depending on the design choice. Multiple oil and multiple water tanks may be used if desired. Multiple oil tanks may be connected with oil equalizing lines and multiple water tanks may be connected with water equalizing lines. A divider may divide a single tank into a water storage compartment and an oil storage compartment if desired. FIG. 5A shows a tank 17 divided into oil and water compartments by a divider 19. In the embodiment shown in FIG. 5A an additional oil storage tank 16 is used alongside the divided tank, and an oil equalizing line 140 and gas equalizing line 142 connect the oil compartment of the divided tank to the oil tank 16. An opening (not shown) at the top of the divider may allow gas pressure equalization between the water and oil compartments. FIG. 5B shows an embodiment in which multiple oil storage tanks are used. A first oil storage tank 16 and a second oil storage tank 16A are connected by an oil equalizing line 144 and a gas equalizing line 146. Multiple water tanks may be connected similarly.

The separator 10 is formed of a vapour tight enclosure. The separator 10 may be a vertically oriented cylinder with domed ends (long axis vertical), but other designs may be used and in some cases the separator 10 may be horizontally disposed, but this is not preferred. The separator 10 may be made of conventional materials and in some embodiments may need only 14.9 psi pressure rating. The embodiment of the wellsite production machine shown has an advantage due to its reliance on gravity to feed the oil storage tank in that a relatively low pressure rating such as 14.9 psi is required on the separator 10, oil storage tank 16 and water storage tank 18. Tanks may be designed to hold higher pressures than are required, for example in an embodiment tanks designed for 35 psi are used, but with 14.9 psi relief valves on them to stay as an atmospheric tank rating. In normal operation the pressures in the system are below the relief valve pressures so no vapors are lost to the atmosphere through the relief valves.

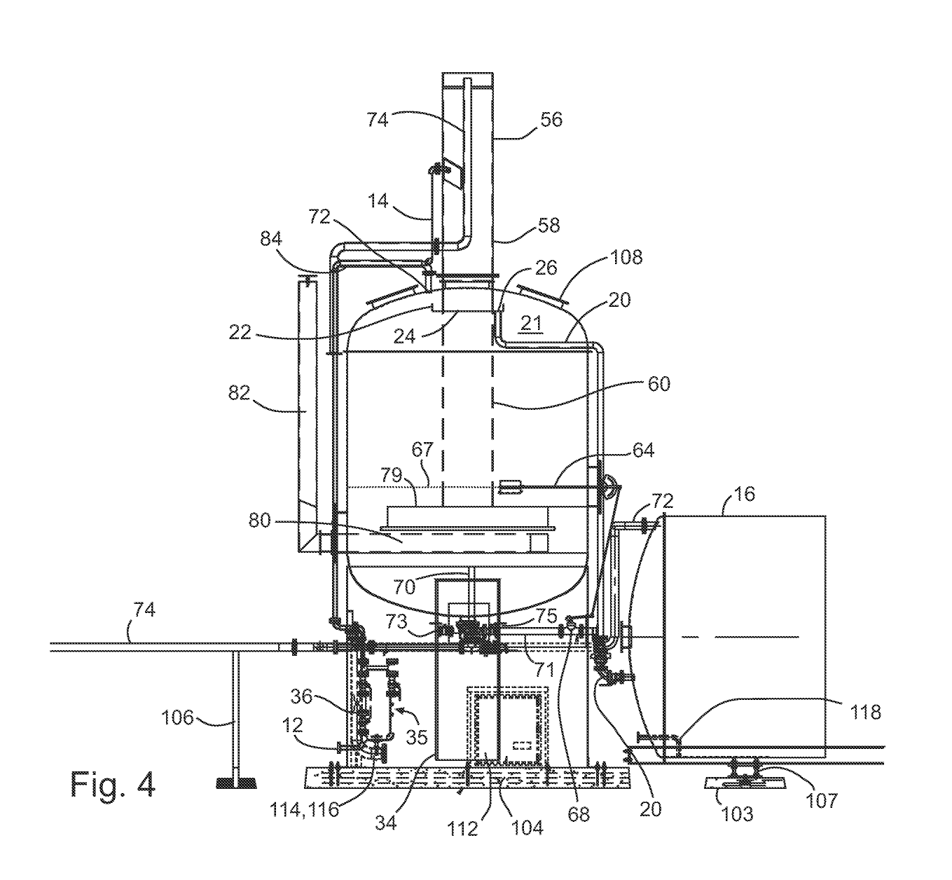

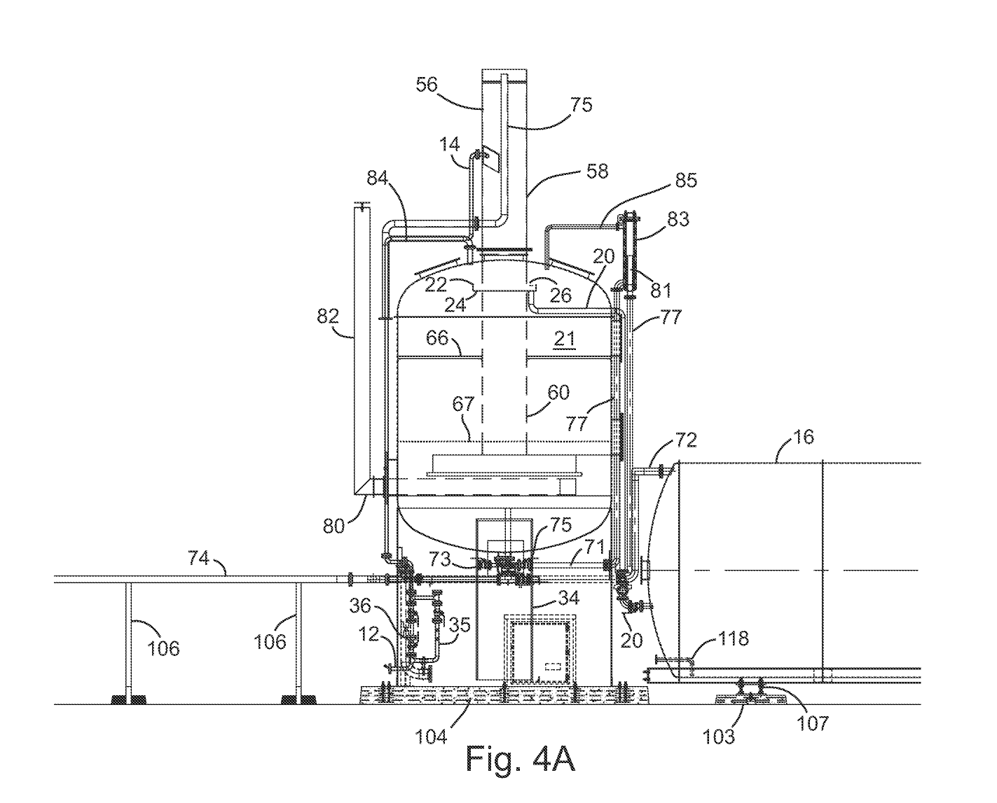

Referring to FIG. 4, the separator 10 has a liquids discharge line 20 and an oil discharge level. The oil discharge level may be anywhere in the separator 10 providing it is above any water-oil level, but may be in an upper part of the separator 10 as created by the lip 22 on oil pan 24 for oil to spill over from the separator 10 into the oil pan 24. The liquids discharge line 20 may have an opening 26 forming an exit from oil pan 24 below lip 22 for oil to be discharged from the separator 10 into the oil storage tank 16.

The separator 10 includes a standpipe 56 extending vertically within the vapour tight enclosure. By vertically here is meant functionally vertically. The standpipe 56 could be placed on an angle but would still extend vertically. The standpipe 56 has an upper part 58 and a lower part 60. The inlet line 14 is connectable to a well (not shown) and includes conventional fittings, valves, gauges and controls as would be found on typical production facility lines from wells. The inlet line 14 opens into the upper part 58 of the standpipe 56 for discharge of fluids from the well into the standpipe 56. A water level detector 64 in the separator 10 defines a water-oil level 67 within the vapour tight enclosure of the separator 10. A water dump control 68 is responsive to the water level detector 64 to open when the water level exceeds the defined water-oil level 67. Water drains by gravity along lines 70 and 71 to the water storage tank 18. Valve 73 may be provided on an extension of line 71 past line 70 to allow for draining of the separator 10, and valve 75 may be provided on line 71 to isolate line 71 from the separator 10 when needed.

The head of water and oil in the separator 10 ensures sufficient pressure to force the water into the water tank 18. The lower part 60 of the stand pipe 56 extends below the water-oil level 67. A vent 72 is provided for gases to escape from the vapour tight enclosure. Gases are preferably directed via the vent 72 along line 74 to a flare stack assembly 76. A conventional pressure relief valve (not shown) is also provided on the separator 10 in accordance with applicable safety standards. Gases from the top of stand pipe 56 may be directed along line 75 to the flare line 74. In an embodiment line 74 uses 8″ diameter pipe to allow high volumes of gas, for example up to 10 million scfd, to be sent to the flare when needed without causing elevated back pressure on the separator and storage tanks. In an embodiment, the 8″ line allows large volumes of gas to be flared without making the separator and storage tanks pressures more than 10 psi.

Oil storage tank 16 is preferably a horizontally disposed cylindrical tank with domed ends as shown. If the oil storage tank 16 were vertically oriented, then the separator 10 would have to be correspondingly higher to allow the separator 10 to drain by gravity into the oil storage tank 16. However, at some additional cost, the oil storage tank 16 could be formed of multiple vertically oriented tanks or even a coiled pipe. The oil storage tank 16 has a liquids input port 28 to which the liquids discharge line 20 is connected. Within the oil storage tank 16 is a high level line 30 established by a high level detection apparatus 32. When oil in the tank reaches the high level line 30, the high level detection apparatus 32 shuts off a valve 36 on the line 14 to prevent further fluids from the well from entering the separator 10. The oil discharge level of the separator is at or above the high level line 30 of the storage tank 16 so that liquids in the separator 10 may flow by gravity into the storage tank 16. Water that has accumulated in the oil storage tank 16 may be retrieved via recycle line 118.

The separator 10 may be mounted above an enclosure or housing 34 that provides environmental protection for controls, valves and gauges for example forming part of meter run 35. The meter run 35 measures how much gas is going to the flare on line 74. Various meters can be used. This is required to determine the amount of money to pay the government as carbon tax. If a compressor is used, the meter run 35 could be on the discharge of the compressor. In an embodiment an ultrasonic gas meter is used that does not rely on differential pressure to obtain a reading. The ultrasonic meter uses sound waves to determine how much gas is passing through the flare line.

The enclosure 34 may be circular, insulated, made of metal such as steel and welded to the separator 10. A heat tracing system 112 may also be used to circulate fluid through the critical lines and prevent freezing. Water storage tank 18 may be connected via a line 40 to a water outlet 42 in the separator 10. There may be a water level operated dump mechanism 44 in the separator 10 for dumping water from the separator 10 into the water storage tank 18. Any suitable or conventional water level operated dump mechanism may be used.

The separator 10 in some embodiments need not entirely contain the standpipe 56. The upper part 58 of the standpipe 56 may extend out of and above the vapour tight enclosure of the separator 10. The function of the upper part 58 of the standpipe 56 is to provide a head of fluid from the well so that the fluid from well, which comprises water and oil, is driven below the standpipe 56 and out into the water that accumulates in the lower part of the separator 10. A heater 80 is located within the vapour tight enclosure of the separator 10 below the water-oil level 67. The heater 80 may in some embodiments be any suitable heater, but may incorporate a burner tube 82 in which gases collected from the vapour tight enclosure are burned. The gases may be supplied to the heater 80 from the vent 72 along line 84. The gases may also be supplied to a desiccant drying tower (not shown) via line 114 or a sweetening tower (not shown) via line 116. A coalescing hood 79 may be provided above the heater 80. The purpose of the coalescing hood 79 is to assist in coalescence of water droplets in a water-in-oil emulsion or oil droplets in an oil-in-water emulsion that descends down the standpipe 56 into the water dominant part of the separator 10. As the oil emerges in the water section, the oil droplets coalesce and move upward. The hood 79 forms a barrier to movement of the oil and water emulsion so that the fluid has a prolonged travel time in the water dominant part of the separator 10. In another embodiment the separator has insulation outside of the vapor tight enclosure of the separator, with a space between the vapor tight enclosure and the insulation, for example of 1.5″, all the way to the top of the separator. Flameless heaters mounted in the bottom section stand of the heater provide heat that rises up within the space between the separator and the insulation and out the top to keep the separator warm with no fire tube with controls needed.

Another version of the separator 10 is shown in FIG. 4A. In FIG. 4A, the water dump is provided by a syphon system. In the syphon dump, water discharge line 71 is connected to a syphon loop 77 that runs up the side of the separator 10 then back down again and out to the water tank 18. The line 71 terminates in the water tank 18 at a level chosen so that when water is above a pre-defined level in the separator 10, the water will spill out into the water tank 18. This level may be adjusted by a sliding sleeve 81 that slides in a tube 83 extending upward from the top of the syphon loop 77. A line 85 extends from the top of the tube 83 to the top of the separator 10. The sleeve 81 is closed at the top, and the height of the column of fluid in the syphon loop 77 may be adjusted by moving the sleeve 81 up and down. When the sleeve 81 is fully extended upward the syphon may be opened to the separator 10, for example for removing an air lock or allowing the syphon to drain. In a part of the separator that may be referred to as a Hay section 21, a separate screen 66 may be provided that supports wood strips or the like in the oil to help make oil droplets coalesce. The storage tanks can operate at the same pressure (preferably in the range of 5 to 10 psi) that the separator operates at, so that valves are not needed to hold pressure between the separator and the tanks. The elevated position of the separator allows fluids to run out by gravity instead of pushed out by pressure, with no controls being needed. The pressure may be kept equalized by piping that allows gas to move around as needed.

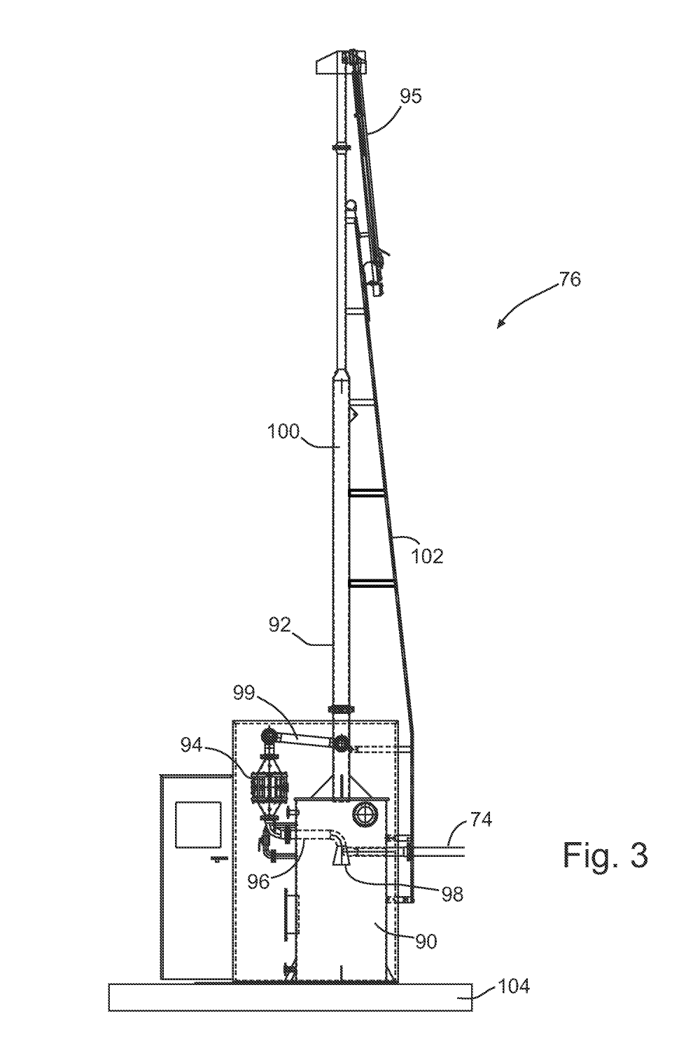

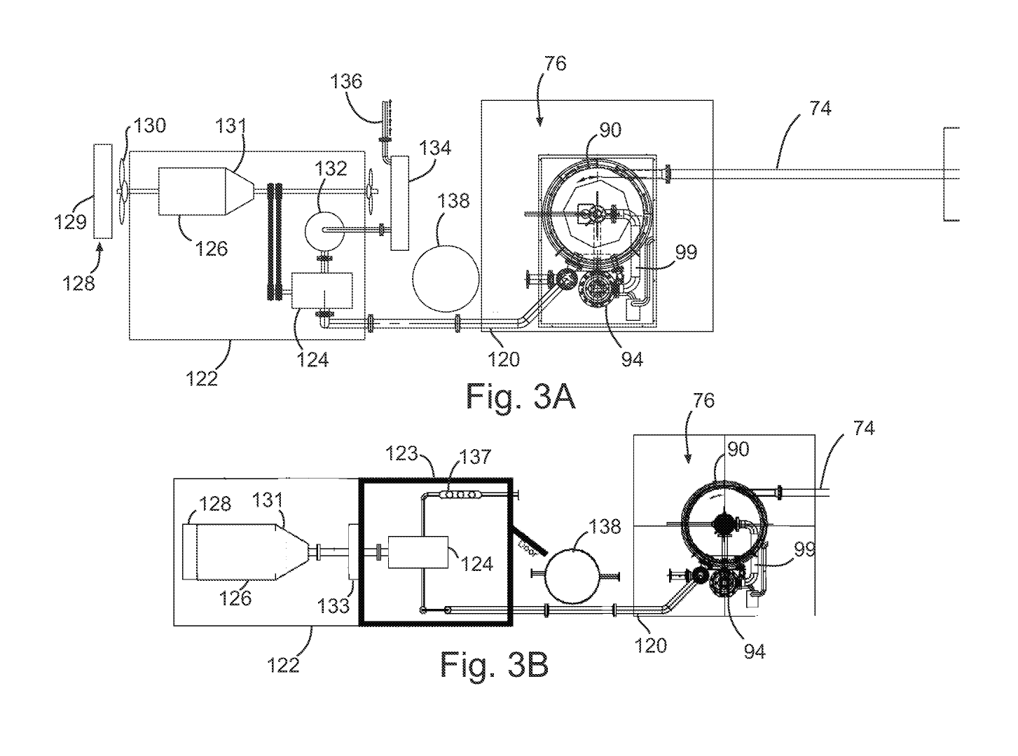

Gases from the vent 72 may be supplied along line 74 to a sales line (not shown) or to the flare stack assembly 76. The line 74 preferably slopes downward away from the separator 10 down to the flare stack assembly 76. The slope may be for example 1 in 150, so that liquids condensing in the line 74 are conveyed towards the flare stack assembly 76. As shown in FIG. 3, the flare stack assembly 76 may comprise a liquids drop out tank 90, flare stack 92 and detonator arrestor 94 on detonation arrestor (DA) line 96 between the liquids dropout tank 90 and flare stack 92. Flare stack 92 may be conventional, with conventional support (not shown) and ignitor 95. The DA line 96 is provided with a receiving port 98 for collecting gases, and a portion 99 that offsets the detonation arrestor 94 so that the detonation arrestor 94 is not gravitationally in line with the flare stack 92. The portion 99 is also sloped downward so that fluids condensing after the detonation arrestor 94 drain towards the flare stack 92, to the bottom of flare stack 92, then through chamber 100 and fluids return line 102 into liquids dropout tank 90. This acts to protect the DA from plugging. Chamber 100 may be formed as the upper part of dropout tank 90, and separated from it by a plate (not shown). Fluids collect on plate (not shown) then flow into the return line 102, which opens out into both the tank 90 and chamber 100. The flare system may comprise a flare knockout and flare combined into one so that it is more effective and more economical to purchase and operate. The flare may be equipped with a self adjusting flare tip that maintains complete combustion of the flare gas for smokeless burning when flaring and holds back pressure on the whole system so it all runs at the same pressures. For example, the Prism Self Adjusting Sonic Flare™ automatically adjusts the exit opening to allow gas to be released while maintaining 5 psi upstream so that the whole system such as the Separator-Treater and storage tanks and all the piping all run at 5 psi right out to the sonic flare tip that is holding the pressure back on the whole system. The self adjusting flare uses the 5 psi pressure to create sonic velocity around the cylindrical head to create a huge influx of air that completely burn the hydrocarbon vapor very efficiently and leaves no smoke from the flame.

For an application where there the flare used does not hold back pressure, an inflatable back pressure will be used to maintain pressure, for example 5 psi, on the whole well site and the back pressure will release to flare the extra gases to be burnt.

Gas from the flare line 74 may be provided to a fuel conditioning skid that separates the liquid out of the gas and further dries the gas with dessicant beads. The fuel from the skid may be provided to a fuel gas system to operate engines and heaters at the well site. The skid also eliminates salts and contaminants from the fuel gas system to reduce residue on engine valves and pistons and to avoid contaminating and plugging gas heaters. In an embodiment, a gas driven variable speed pump jack drive system may be provided, operating using the gas from the fuel conditioning skid instead of burning diesel in generator sets or requiring power lines to be provided. Load sensors may control the speed of the drive to ramp hydraulic motors up and down to manage stroke speeds and rod load stress.

Gas from the flare line 74 may also be provided to a sales line as shown in FIG. 3A. In FIG. 3A, the flare stack assembly 76 is designed as shown in FIG. 3, except that a line 120 extends from the tank 90 or 100 to a compressor station 122. Compressor station 122 includes a compressor pump 124 driven by an engine 126. The compressor pump may for example be a reciprocating or screw type pump. In an embodiment the compressor pump may be or include a self adjusting variable speed compressor. In an embodiment the pump may be a Prism Booster Screw™. In an embodiment where there is no sales line, the compressor may be omitted. The engine 126 has a cooling unit 128 with radiator 129, cooling fan 130 and clutch 131. Gas pumped by the compressor pump 124 is passed through circulator bypass 132 and cooler 134 to a line 136 that goes out to a sales line (not shown). The pump 124 compresses the gas to a higher pressure so that it can be pumped into the sales line, while the circulator 132 helps drop liquids out of the gas. Cooler 134 is used to cool the gas, which has been heated by the pump 124. The cooler 134 may be a combi-cooler. An optional sweetener 138 with granular sweetening compound may be connected to line 120 by a relief bypass line (not shown) in case of emergency shut down failure. In an embodiment the sweetener 138 is connected to line 120 to sweeten the gas heading to pump 124 to strip the sulfur out of the gases before they are sold in the pipe line. As the equipment is operating at less than 14.9 psi, low cost sweetening tanks can be used. Atmospheric designed sweeteners are much cheaper to purchase and maintain compared to registered pressure vessels. FIG. 3B shows an alternative embodiment of compressor station 122. In FIG. 3B a building enclosure 123 surrounds the compressor 124 but excludes the engine 126 which sits outside. Compressor 124 is in line with engine 126 and compressor cooler 133 is located between the engine and compressor outside the enclosure. Gas exiting the compressor passes through a coalescing filter 137 to remove liquids before the gas passes to a sales line (not shown).

The well site production machine may be installed in an efficient method using pre-fabricated concrete slabs 103, 104, 105 and height adjustable support posts 106, 107, which are sized according to the load they will support. All major components including the concrete slabs 10, 204, 105 may be pre-fabricated offsite then transported to the well site where the well site production machine is to be installed. The slabs 103, 104 and 105 may be made of other construction materials such as steel beams, but concrete slabs are inexpensive. Thus the concrete support slabs 103, 104, 105, separator 10, storage tanks 16 and 18 and height adjustable support posts 106, 107 may be all fabricated in an off-site location then transported to a wellsite. At the well site, the separator 10 and storage tanks 16, 18 may be mounted on the concrete support slabs 104 and height adjustable support posts 106 and then the vertical location of each of the separator 10 and the storage tanks 16, 18 leveled and adjusted using the height adjustable support posts. Manways 108 may be located on the separator 10 and the storage tanks 16 and 18. Concrete slabs 104 may also be used to support steps 110 and walkway 112 which provide access for personnel to service the top of the tanks. Oil storage tank 16 may be equipped with a floating load out hose inside to allow dry oil to be shipped before hitting wet oil. Oil storage tank 16 may be equipped with a built on LACT unit to record and document oil sold from the tank for the oil company, land owner or oil buyers.

The modular prefabrication method may also be used to install the flare line 74 and flare stack assembly 76. The flare stack assembly 76, including flare line 74, is first fabricated off site at any suitable location, then transported to a wellsite along with the separator 10, tanks 16 and 18 and associated components. At the well site, the installation method then proceeds with mounting the flare stack assembly 76 including the flare line 74 on the concrete support slabs 104 and height adjustable posts 106, and adjusting the flare line 74 with the height adjustable posts 106 to have a downward slope with increasing distance from the separator 10.

1. A wellsite production machine, comprising:
a separator connectable to a wellhead, the separator having a liquids discharge line and an oil discharge level;
an oil storage tank having a liquids input port to which the liquids discharge line is connected; and
the storage tank having a high level line established by a high level detection apparatus, the oil discharge level of the separator being at or above the high level line of the storage tank so that liquids in the separator may flow by gravity into the storage tank.

2. The wellsite production machine of claim 1 in which the separator has a long axis that is vertically oriented, and the storage tank has a long axis that is horizontally oriented.

3. The wellsite production machine of claim 2 in which the separator is cylindrical.

4. The wellsite production machine of claim 2 in which the storage tank is cylindrical.

5. The wellsite production machine of claim 1 in which the separator is mounted above an enclosure that provides environmental protection for controls.

6. The wellsite production machine of claim 1 in which the separator is rated to withstand pressures at or below 14.9 psi.

7. The wellsite production machine of claim 1 in which the storage tank is rated to withstand pressures at or below 14.9 psi.

8. The wellsite production machine of claim 1 further comprising a water storage tank connected to a water outlet in the separator.

9. The wellsite production machine of claim 8 further comprising a water level operated dump mechanism in the separator for dumping water from the separator into the water storage tank.

10. A method of installing a wellsite production machine, the method comprising:
fabricating concrete support slabs, a separator, a storage tank and height adjustable support posts;
transporting the fabricated concrete support slabs, separator, storage tank and height adjustable support posts to a wellsite;
mounting the separator and storage tank on the concrete support slabs and height adjustable support posts; and
levelling and adjusting the vertical location of each of the separator and the storage tank using the height adjustable support posts.

11. The method of claim 10 further comprising:
fabricating a flare stack assembly, including a flare line;
transporting the fabricated flare stack assembly to a wellsite;
mounting the flare stack assembly including the flare line on the concrete support slabs and height adjustable posts; and
adjusting the flare line with the height adjustable posts to have a downward slope with increasing distance from the storage tank.

12. A separator, comprising:
a vapour tight enclosure;
a standpipe extending vertically within the vapour tight enclosure, the standpipe having an upper part and a lower part;
an inlet line for fluids from a well, the inlet line opening into the upper part of the standpipe for discharge of fluids from the well into the standpipe;
a water level detector in the vapour tight enclosure that defines a water-oil level within the vapour tight enclosure;
a water dump control responsive to the water level detector to open when a water level exceeds the defined water-oil level;
the lower part of the standpipe extending below the water-oil level;
an oil discharge line having an opening for receiving oil from the vapour tight enclosure and above the water-oil level; and
a vent for gases to escape from the vapour tight enclosure.

13. The separator of claim 12 in which the upper part of the standpipe extends out of and above the vapour tight enclosure.

14. The separator of claim 12 further comprising a heater located within the vapour tight enclosure below the water-oil level.

15. The separator of claim 14 in which the heater is a burner tube in which gases collected from the vapour tight enclosure are burned.

16. The separator of claim 12 in which the oil discharge line forms an exit from an oil pan located in the vapour tight enclosure above the water-oil level, the oil pan having a lip for oil in the vapour tight enclosure to spill over and be collected by the oil discharge line.

17. The separator of claim 12 in which the vapour tight enclosure is a cylinder with a vertical longitudinal axis.

18. A flare stack assembly, comprising:
a flare stack;
a dropout tank;
an inlet line having an opening into the dropout tank, the inlet line being connectable to a separator;
a detonation arrestor line extending out of the dropout tank through a detonation arrestor and downward into the flare stack; and
a fluids return line between a bottom of the flare stack and the dropout tank.
